(19) United States
(12) Patent Application Publication
(10) Pub. No.: US 2017/0103528 A1
(43) Pub. Date: Apr. 13, 2017

(54) VOLUMETRIC TEXTURE SCORE

(71) Applicant: OHIO STATE INNOVATION FOUNDATION, Columbus, OH (US)

(72) Inventors: Barbaros Selnur ERDAL, Columbus, OH (US); Elliott D. CROUSER, Columbus, OH (US); Bradley D. CLYMER, Columbus, OH (US)

(21) Appl. No.: 15/314,534

(22) PCT Filed: May 27, 2015
(86) PCT No.: PCT/US15/32645

§ 371 Date: Nov. 29, 2016

Related U.S. Application Data
(60) Provisional application No. 62/004,410, filed on May 29, 2014.

(51) Int. Cl. G06T 7/00

(52) U.S. Cl. CPC G06T 7/0012; G06T 2207/10081; G06T 2207/30061

(57) ABSTRACT

During LTS calculations, first gray level transformations are applied to DICOM images, followed by two-point correlation function based threshold calculations being applied to each pixel (voxel) in the given volume. Finally these calculations lead into estimation of textures within the given volume (LTS). This algorithm, which is initially implemented in JAVA programming language, can be replicated in other programming languages as well. The novel LTS image analysis approach implemented herein is shown to strongly correlates with severity of pulmonary diseases based upon standard PFT criteria, and these correlations were obtained using relatively low grayscale resolution (16 gray levels) images. This implies that the computer image analysis approach could reduce the risks of radiation exposure while providing a more objective assessment of disease progression for clinical and research applications.

### BACKGROUND

Chest CT scans are commonly used to clinically assess disease severity in patients presenting with pulmonary sarcoidosis. Despite their ability to reliably detect subtle changes in lung disease, the utility of chest CT for guiding therapy is limited by the fact that image interpretation by radiologists is qualitative and highly variable.

### SUMMARY

Disclosed herein are systems and methods for computerized CT image analysis tool that provides quantitative and clinically relevant information. A two-point correlation analysis approach may be used reduced the background signal attendant to normal lung structures, such as blood vessels, airways and lymphatics while highlighting diseased tissue.

In accordance with the present disclosure, there is disclosed a method for determining a Volume Texture Score (VTS), such as a Lung Texture Score (LTS) from an image set. The method may include: using a first copy of the image set, applying a histogram equalization to create an equalized image set; reducing image gray levels of the first copy; using a second copy of the image set to create an image mask; applying the image mask to the equalized image set to create filtered lung images; estimating an amount of lung tissue (EL) in comparison to a volume of interest; reducing the filtered lung images; performing a percent textured pixel (PTP) analysis by comparing each pixel in the filtered lung images to its surrounding pixels; determining how different a pixel's surroundings are as compared to itself by applying a probabilistic threshold is applied; storing the result if a pixel's difference is greater that the probabilistic threshold; and determining the LTS in accordance with the relationship LTS=PTP/EL.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a diagram of a structure of a computed tomography (CT) apparatus according to an exemplary embodiment of the present invention;

FIGS. 2A-2C and FIG. 3 provide is an example operational flow in accordance with the present disclosure to calculate a Lung Texture Score (LTS); and

FIG. 4 illustrates aspects of a Percent Textured Pixel (PTP) measurement technique.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

### Example Environment

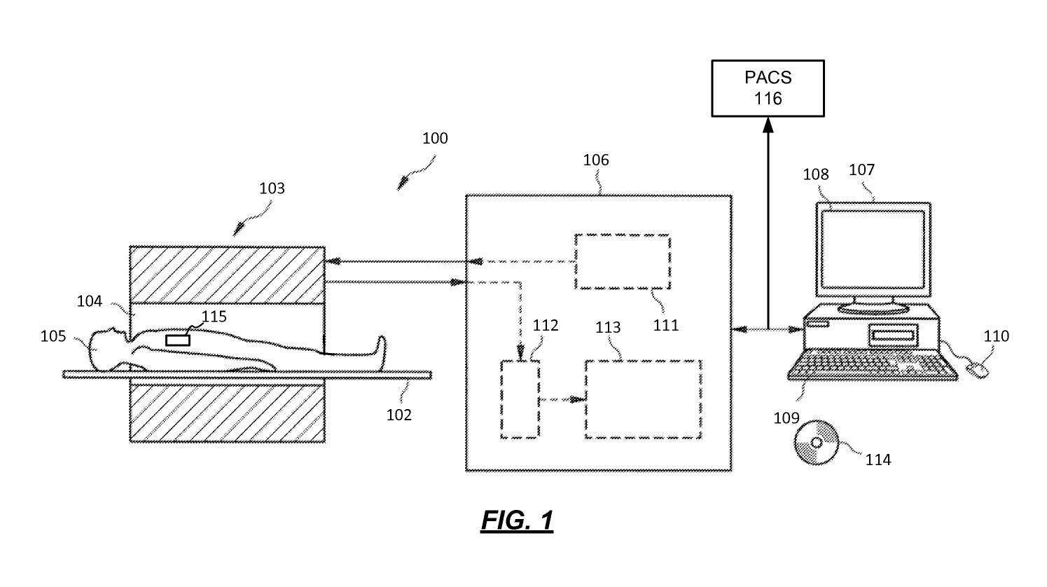

FIG. 1 is a view illustrating a structure of an example computed tomography (CT) apparatus 100 that may be used to acquire image data. The CT apparatus 100 includes a scanner 103 that generates X-ray views used for the CT examination within a measurement space 104 having a patient table 102. A controller 106 includes an activation unit 111, a receiver device 112 and an evaluation module 113. During a phase-sensitive flow measurement, CT data are recorded by the receiver device 112, such that CT data are acquired in, e.g., a measurement volume or region 115 that is located inside the body of a patient 105.

An evaluation module 113 prepares the CT data such that they can be graphically presented on a monitor 108 of a computing device 107 and such that images can he displayed. In addition to the graphical presentation of the CT data, a three-dimensional volume segment to be measured can be identified by a user using the computing device 107. The computing device may include a keyboard 109 and a mouse 110.

Software for the controller 106 may be loaded into the controller 106 using the computing device 107. Such software may implement a method(s) to process data acquired by the CT apparatus 100, as described below. It is also possible the computing device 107 to operate such software. Yet further, the software implementing the method(s) of the disclosure may be distributed on removable media 114 so that the software can be read from the removable media 14 by the computing device 107 and be copied either into the controller 106 or operated on the computing device 107 itself.

The image data may be stored in a PACS (Picture Archiving and Communication System) 116, which provides for short and long term storage, retrieval, management, distribution and presentation of medical images. The PACS 116 allows the CT apparatus 100 to capture, store, view and share all images. The universal format for PACS image storage and transfer is DICOM (Digital imaging and Communications in Medicine).

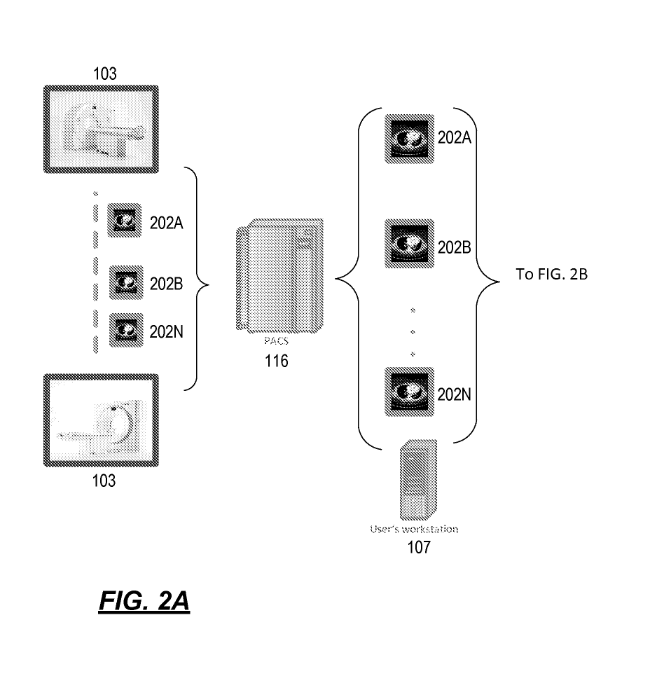

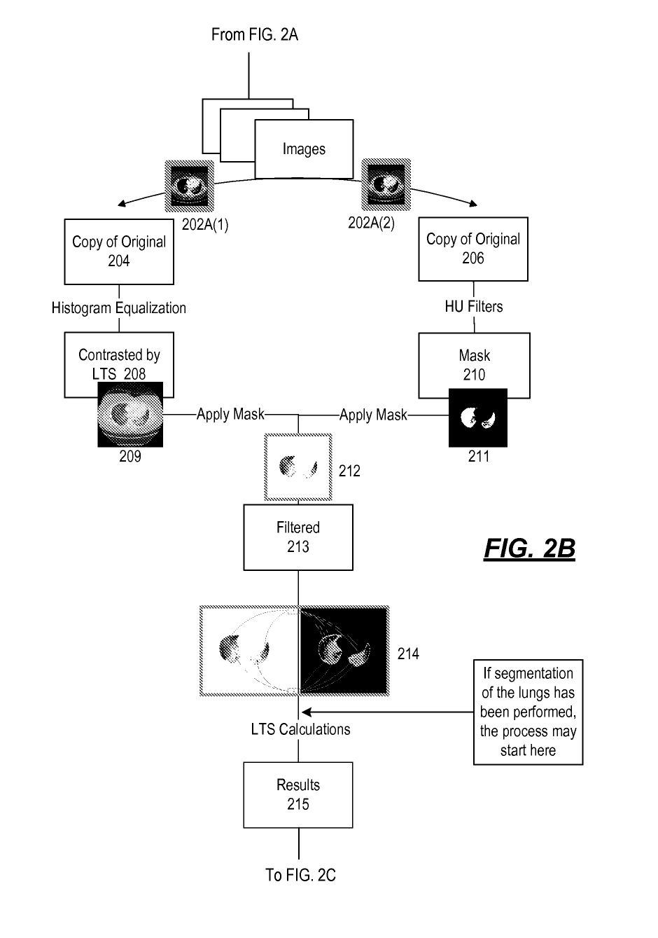

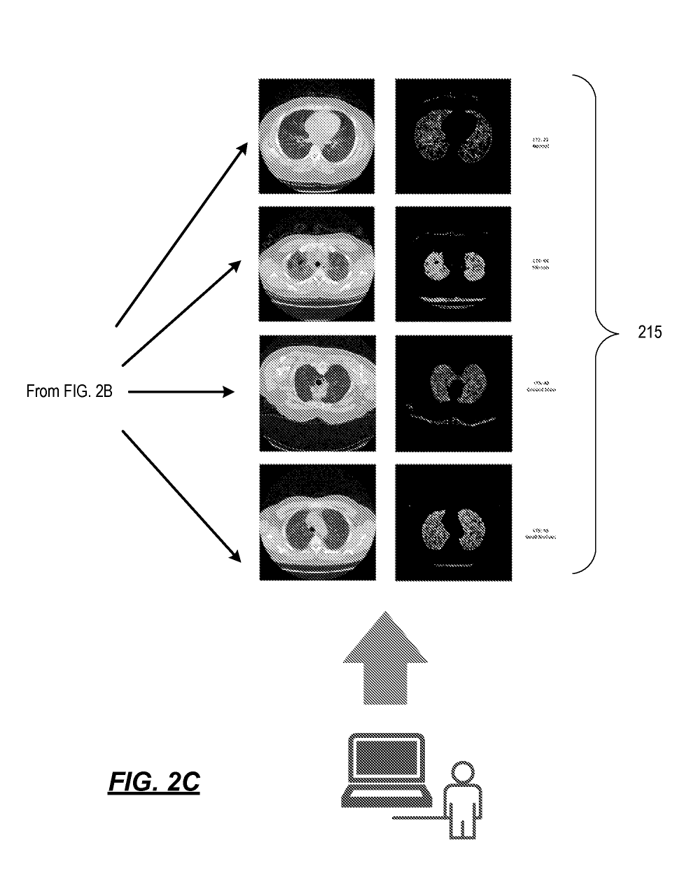

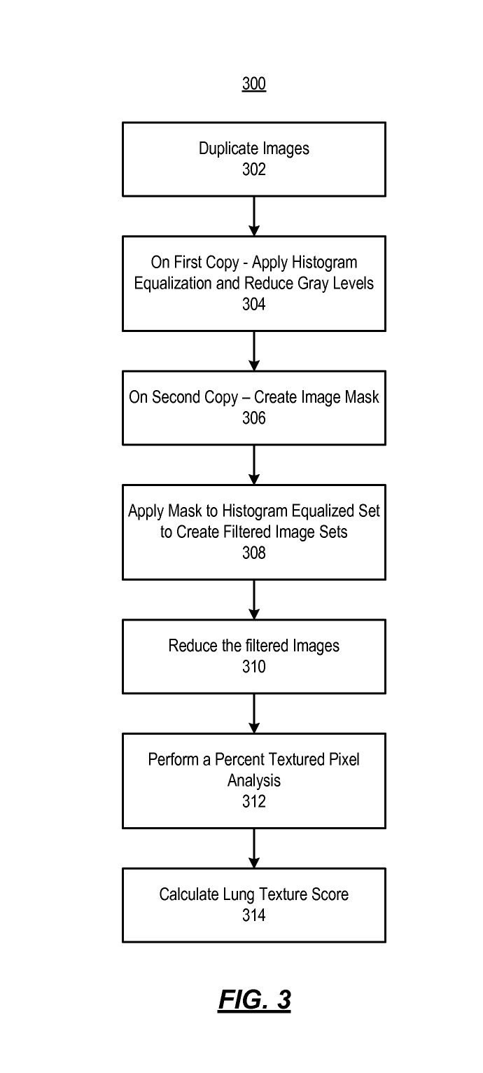

In an implementation, the data acquired by the CT apparatus 100 of FIG. 1, may be processed as described below with reference to FIGS. 2A-2C and 3. At 302, images are duplicated. For example, images 202A-202N may be duplicated to be images 202A(1), 202A(2) 202N(1), 202N(2). A radiologist may see image 202A(1), which is a 16-bit (or higher) DICOM image.

At 304, using a first copy 204 of the images (e.g., 202A(1) . . . 202N(1)), histogram equalization is applied, and image gray levels are reduced from 16-bit to, e.g., 8-bit. The resulting image set 209 is shown in FIG. 2B. At 306, using a second copy 206 of the images (e.g., 202A(2) . . . 202N(2)), an image mask for, e.g., lungs (or other organ, portion of the body) are created. For example, based on Hounsfield Units (HU), the image masks may be created to filter out the lungs from the chest CTs. The Hounsfield Units values are stored in the original DICOM files on a per image slice. The image mask 211 is shown in FIG. 2B.

At 308, the image mask 211 is applied to the histogram equalized image set 209. As such, filtered image sets 214 are created, which are ready for lung texture score (LTS) calculations at 314. It is noted that if segmentation of the lungs had been performed in advance, the process may begin here, as shown in FIG. 2B, During this process an estimate amount for the lung tissue in comparison to the volume of interest is calculated. This ratio will later be used during LTS score generation. Herein, this will be called the estimated lung (EL). The EL is determined as follows:

EL=Total Volume (# of pixels)/Lung (# of pixels in the mask generated at 306)

At 310, during the LTS Calculations, first, the filtered lung images 214 are reduced from 8-bit (256 gray levels) to 4-bit (16 gray levels), It is noted that this parameter can be set to gray levels that are other than 4-bit. After the operation at 310, the result is one of 16 possible gray levels stored.

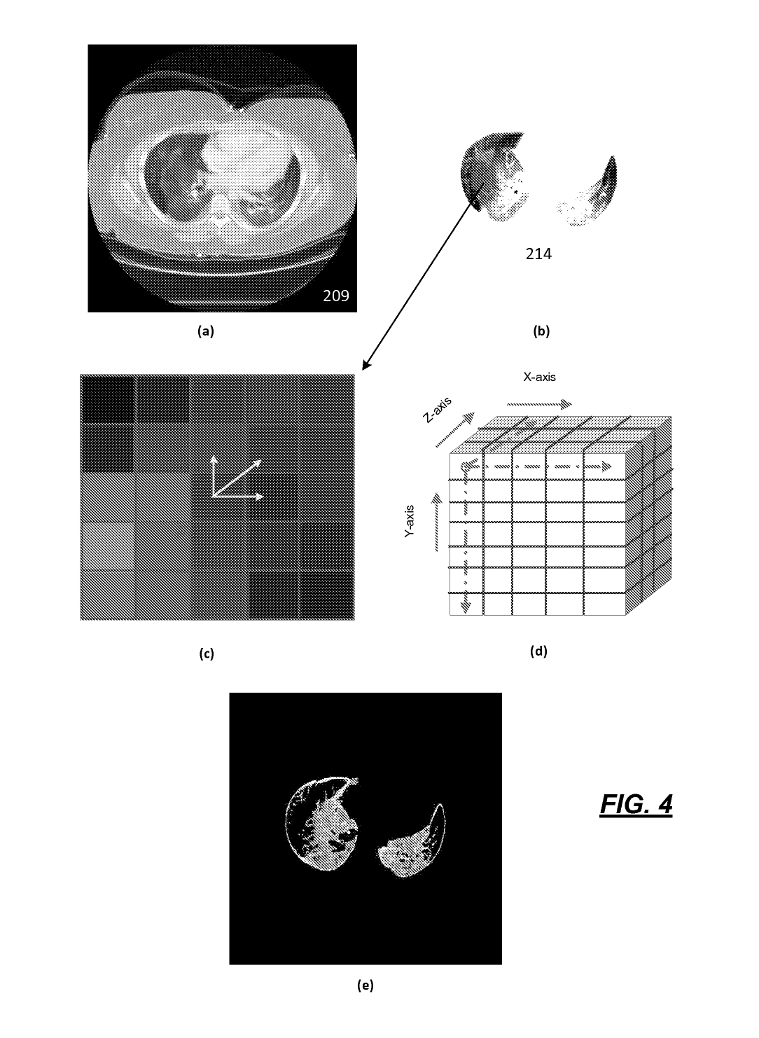

At 312, a percent textured pixel (PTP) analysis is performed. With reference to FIG. 4, samples from a region in an image are compared samples from another region, and the correlation between the pixel populations is reported. In accordance with present disclosure, each pixel is compared to its surrounding pixels, for a given parametric distance. For example, beginning with the image set 209 (FIG. 4(a)), which is converted to the filtered image sets 214 (FIG. 4(b)), if a pixel comparison is made on a 2-pixel distance basis on the filtered image sets 214, 25 in-place comparisons would be made for a 20 image (FIGS. 4(c)) and 125 comparisons would be made for a 3D image (FIG. 4(d)). With each comparison, it is determined how different a pixel's surroundings are, as compared to itself. In other words, on a per-pixel basis, a measure of disagreement with its surroundings is made. The percentage of disagreements are then stored in a matching 3D grid. Then, on this 3D grid (which one to one corresponds to the CT volume), a probabilistic threshold is applied, If pixels have relatively large disagreements with their surroundings (e.g., 75% (or other) of the pixels that surround the pixel are different from the pixel of interest), those pixels are stoned, and the rest disregarded, as shown in FIG. 4(e). All remaining pixels in the 3D grid, are integrated and counted as percentage of pixels that have significant textural differences to its surroundings. As used herein, this is the percent textured pixel (PTP), which is a volumetric measure.

At 314, a lung texture score (LTS) is determined. The LTS calculation is determined as a function of the PIP divided by EL (Estimated lung measurement), which was determined at step 308:

LTS=PTP/EL.

Resulting images 215 are shown in FIG. 2C, which show normal and diseased lungs. The LTS estimates a score that strongly correlates with pulmonary function parameters (FVC, TLC, and DLCO), which is the current standard for estimating lung disease severity in patients with many pulmonary diseases. However, the LTS provides a more objective measure of the overall burden of pulmonary disease, as compared to pulmonary function parameters. As such the LTS may be used as an objective measure to detect pulmonary diseases, such as sarcoidosis, idiopathic pulmonary fibrosis (IPF), and others. Further, the LTS of the present disclosure demonstrates that a computer image analysis approach could reduce the risks of radiation exposure, while providing a more objective assessment of disease progression for clinical and research applications.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one o put device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for determining a Lung Texture Score (LTS) from an image set, comprising:
using a first copy of the image set, applying a histogram equalization to create an equalized image set;
reducing image gray levels of the first copy;
using a second copy of the image set to create an image mask;
applying the image mask to the equalized image set to create filtered lung images;
estimating an amount of lung tissue (EL) in comparison to a volume of interest;
reducing the filtered lung images;
performing a percent textured pixel (PTP) analysis by comparing each pixel in the filtered lung images to its surrounding pixels;
determining how different a pixel's surroundings are as compared to itself by applying a probabilistic threshold is applied;
storing the result if a pixel's difference is greater that the probabilistic threshold; and
determining the LTS in accordance with the relationship LTS=PTP/EL.

2. The method of claim 1, wherein the gray levels of the first copy are reduced to 8-bit.

3. The method of claim 1, wherein the image mask is created in accordance with Hounsfield Units (HU), and wherein the image mask filters out the lungs from chest CTs.

4. The method of claim 1, wherein the filtered lung images are reduced to 4-bits.

5. The method of claim 1, wherein a pixel comparison is made on a 2-pixel distance.

6. The method of claim 1, wherein the probabilistic threshold is 75% of the pixels that surround the pixel are different from the pixel of interest.

7. A method of determining a Lung Text Score (LTS) from an image set, comprising
receiving the image set acquired by a computed tomography (CT) apparatus;
reducing gray levels in the image set to determine a reduced image set;
determining image masks from the image set;
applying the image masks to the reduced image set to create a filtered image set;
estimating an amount of lung tissue in comparison to a volume of interest to determine an estimated lung (EL) ratio;
determining a percent textured pixel (PIP) analysis by comparing samples from a region in an image are to samples from another region; and
determining the LTS from the PIP and the EL.

8. The method of claim 7, wherein the gray levels in the reduced image set are 8-bit levels.

9. The method of claim 7, wherein the portion of the body is an organ.

10. The method of claim 7, further comprising creating the image masks in accordance with Hounsfield Units (HU) associated with each image in the image set to filter out the portion of the body.

11. The method of claim 7, wherein EL=Total Volume (# of pixels)/Lung (# of pixels in the image masks)

12. The method of claim 7, wherein the PTP is determined by comparing each pixel to its surrounding pixels over a predetermined parametric distance.

13. The method of claim 12, wherein the predetermined distance is 2 pixels.

14. The method of claim 7, further comprising:
determining, on a per-pixel basis, a measure of disagreement of each pixel with its surroundings; and
storing the disagreement as a percentage in a 3D grid.

15. The method of claim 14, further comprising:
discarding a pixel if its associated percentage is above a predetermined threshold; and
identifying a number of remaining pixels in the 3D grid to determine the PTP.

16. The method of claim 15, wherein the predetermined threshold is 75%.

17. The method of claim 7, wherein LTS=PTP/EL.

18. The method of claim 7, wherein the LTS provides an objective measure of the overall burden of pulmonary disease, as compared to pulmonary function parameters.

19. The method of claim 7, wherein the LTS provides an objective measure to detect pulmonary diseases.

20. The method of claim 7, further comprising determining the LTS for a portion of a body, wherein the EL equals an amount of tissue in comparison to a volume of interest of the portion of the body interest.
